(19) United States
(12) Patent Application Publication
(10) Pub. No.: US 2009/0189023 A1
(43) Pub. Date: Jul. 30, 2009

(54) AERODYNAMIC HIGH-PERFORMANCE PROFILE FOR AIRCRAFT

(75) Inventor: Volker MIKULLA, OBERPFRAMMERN (DE)

Correspondence Address: YOUNG & THOMPSON, 209 Madison Street, Suite 500, ALEXANDRIA, VA, 22314, US

(73) Assignee: EUROCOPTER DEUTSCHLAND GMBH, DONAUWORTH (DE)

(21) Appl. No.: 12/360,285

(22) Filed: Jan. 27, 2009

(30) Foreign Application Priority Data
Jan. 28, 2008 (DE) 102008006437.8-22

(51) Int. Cl. B64C 21/00; B64C 21/10

(52) U.S. Cl. 244/204

(57) ABSTRACT

Aerodynamic high-performance profile (10), in which, to force a turbulent flow of the boundary layer away from the bottom side (12), a transition strip (16), which extends over the entire length of the rear edge, is situated in direct proximity to the rear edge (15).

### TECHNICAL AREA

The invention relates to an aerodynamic high-performance profile for aircraft, such as fixed-wing and/or rotary-wing aircraft.

### PRIOR ART

An important criterion for the implementation of an aerodynamic high-performance profile is known to be the reduction of its air resistance, inter alia, by maintaining a laminar flow over large components of its profile depth. As a result of the advantageous pressure gradient, attention is particularly directed in this case to the boundary layer on the bottom side of the high-performance profile, which is to press against the bluntly implemented rear edge of the high-performance profile as much as possible, to avoid bubble-shaped flow separation. These separation effects, referred to as stall, which result in a flow interruption and thus in performance losses, are known to be a function of the Reynolds number (Rₑ number). This undesired bubble formation may also occur on rotor blades of the main and tail rotors of rotary-wing aircraft and also decrease the flow around the rotor blade therein and result in losses in regard to the thrust and pitch torques to be generated and occurs—as experiments show—in particular on the blunt rear edge of a rotor blade, because very large opposing pressure gradients may also be present there.

### DESCRIPTION OF THE INVENTION

The invention is based on the object of improving the implementation of profiles having aerodynamic surfaces, in particular of helicopter rotor blades, in regard to the thrust and pitch torques to be generated therewith.

Proceeding from the finding that an undesired bubble formation also occurs on the bottom side of high-performance profiles of aerodynamic bodies, in particular of rotor blades, this object is achieved according to the invention in that for the purpose of achieving a turbulent outflow on the bottom side of a high-performance profile, a transition strip is situated extending over the entire depth of the rear edge.

Further features of the invention result from the subclaims.

According to a preferred embodiment of the invention, the transition strip is implemented as a zigzag band and is glued onto the bottom side of the aerodynamic high-performance profile.

According to a further embodiment of the invention, the transition strip is implemented as a so-called tab, i.e., an interference edge integrated on/in the bottom side of the aerodynamic high-performance profile.

A turbulent outflow on the bottom side of aerodynamic high-performance profiles, in particular of rotor blades having blunt rear edge, is forced for the first time by the invention, which surprisingly results in an increase of the lift and in an improvement of the stabilization of a rotary-wing aircraft equipped therewith.

A transition strip forcing such a turbulent partition layer on the bottom side of the aerodynamic high-performance profile in direct proximity to its rear edge is glued on over the entire depth, i.e., the entire radius of a rotor blade in the simplest case; however, it may also be implemented on the rotor blade bottom side as the tab integrated in the profile of the rotor blade.

Through the implementation according to the invention of an aerodynamic high-performance profile of the type under discussion here, the aerodynamic properties in regard to lift and pitch torque are achieved with negligible rise of the profile resistance. An increase of the rotor thrust is achieved at the same rotor power. A further advantage may be seen in that a lower Reynolds number sensitivity of the high-performance profile and thus lesser aerodynamic effects, such as non-stationary excitations on the rotating rotor of a rotary-wing aircraft, are achieved by the transition strip. This results in a higher service life of the rotor blades and the rotor blade components. This is correspondingly true for the profile of the wing of a fixed-wing aircraft.

The invention is described in greater detail hereafter on the basis of an exemplary embodiment which is schematically illustrated in the drawing.

In the figures:

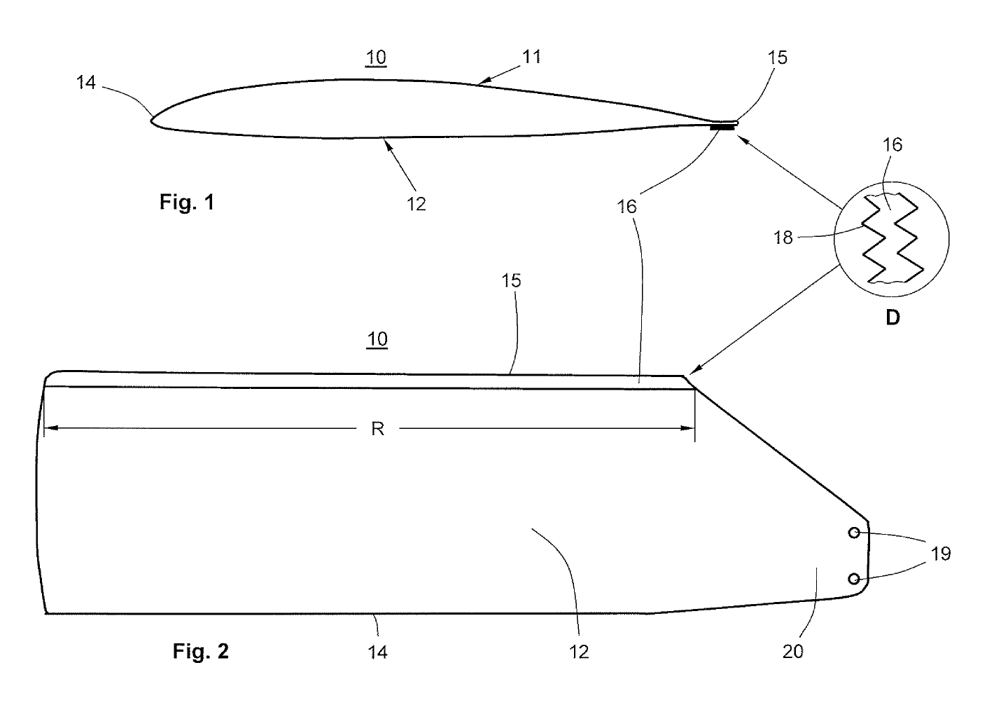

FIG. 1 shows a cross-section of an aerodynamic high-performance profile having blunt rear edge according to the invention for a tail rotor blade of a helicopter and

FIG. 2 shows a view from below of the high-performance profile shown in FIG. 1.

The aerodynamic high-performance profile 10 in the form of a rotor blade for a tail rotor of a helicopter shown in FIG. 1 comprises a strongly curved top surface 11 and a weakly curved lower surface 12 as well as a profile lug 14 and a blunt rear edge 15. It is implemented in such a way that a flow around the profile occurs as much as possible without flow separation over large components of the surface in the event of suitably selected Rₑ number. In order to generate—for the purpose of achieving a turbulent outflow—a turbulent boundary layer on the bottom side of the high-performance profile 10 in direct proximity to the rear edge 15, a transition strip 16 is provided on the bottom side of the rear edge 15. It extends over the entire depth, i.e., the radius R of the rear edge 15 of the rotor blade of the aerodynamic high-performance profile 10, compare FIG. 2.

The transition strip 16 is implemented in the present exemplary embodiment in the form of a zigzag band, as shown in the detail illustration D. It has a thickness of 0.4 mm and a width of 10 mm and is provided with zigzags 18 on its front and rear edges.

The fastening of the transition strip 16 is performed via a permanent adhesive bond, it is also possible to implement it as a so-called tab—control edge—on the profile bottom side by a corresponding surface implementation.

Furthermore, the fastening holes 19 of an attachment flange 20 of the high-performance profile 10, which is implemented as a rotor blade for a tail rotor, may be seen from FIG. 2. The attachment flange 20 is implemented differently if the high-performance profile 10 is implemented as a rotor blade for a main rotor and is dispensed with entirely if the high-performance profile 10 is implemented as an airfoil for a fixed-wing airplane.

Through the use of the transition strip 16 or tab described above, a turbulent outflow is achieved on the bottom side 12 of the profile causing the circulation of the flow and thus for the lift and the momentum and Reynolds number behavior and thus a performance increase in regard to the achievable thrust by approximately 3% or more. This is also true if the aerodynamic high-performance profile 10 described above is implemented as a main rotor blade of a helicopter or as an airfoil of a fixed-wing airplane.

### LIST OF REFERENCE NUMERALS

10 high-performance profile
11 top surface
12 bottom surface
14 profile lug
15 rear edge
16 transition strip
18 zigzag
19 fastening holes
20 attachment flange
R radius
D detail illustration of the transition strip

1. An aerodynamic high-performance profile (10) for aircraft, having curves to achieve different laminar boundary layers on its top and bottom sides (11, 12) and blunt rear edge (15), characterized in that, for the purpose of achieving a turbulent outflow on the bottom side (12) of the high-performance profile (10), a transition strip (16) is situated extending over the entire depth (radius) of the rear edge (15) of the profile (10).

2. The aerodynamic high-performance profile according to claim 1, characterized in that the transition strip (16) is implemented as a zigzag band (zigzag 18).

3. The aerodynamic high-performance profile according to claim 1, characterized in that the transition strip (16) is glued on.

4. The aerodynamic high-performance profile according to claim 1, characterized in that the transition strip (16) is implemented as a tab integrated in the bottom side (12) of the high-performance profile (10) close to the rear edge (15).

5. The aerodynamic high-performance profile according to claim 1, characterized in that the high-performance profile is implemented as the main rotor blade of a helicopter.

6. The aerodynamic high-performance profile according to claim 1, characterized in that the high-performance profile (10) is implemented as a tail rotor blade for a helicopter.

7. The aerodynamic high-performance profile according to claim 1, characterized in that the high-performance profile (10) is implemented as an airfoil of a fixed-wing aircraft.

8. The aerodynamic high-performance profile according to claim 2, characterized in that the transition strip (16) is glued on.

9. The aerodynamic high-performance profile according to claim 2, characterized in that the transition strip (16) is implemented as a tab integrated in the bottom side (12) of the high-performance profile (10) close to the rear edge (15).

10. The aerodynamic high-performance profile according to claim 2, characterized in that the high-performance profile is implemented as the main rotor blade of a helicopter.

11. The aerodynamic high-performance profile according to claim 3, characterized in that the high-performance profile is implemented as the main rotor blade of a helicopter.

12. The aerodynamic high-performance profile according to claim 4, characterized in that the high-performance profile is implemented as the main rotor blade of a helicopter.

13. The aerodynamic high-performance profile according to claim 2, characterized in that the high-performance profile (10) is implemented as a tail rotor blade for a helicopter.

14. The aerodynamic high-performance profile according to claim 3, characterized in that the high-performance profile (10) is implemented as a tail rotor blade for a helicopter.

15. The aerodynamic high-performance profile according to claim 4, characterized in that the high-performance profile (10) is implemented as a tail rotor blade for a helicopter.

16. The aerodynamic high-performance profile according to claim 2, characterized in that the high-performance profile (10) is implemented as an airfoil of a fixed-wing aircraft.

17. The aerodynamic high-performance profile according to claim 3, characterized in that the high-performance profile (10) is implemented as an airfoil of a fixed-wing aircraft.

18. The aerodynamic high-performance profile according to claim 4, characterized in that the high-performance profile (10) is implemented as an airfoil of a fixed-wing aircraft.

19. The aerodynamic high-performance profile according to claim 8, characterized in that the transition strip (16) is implemented as a tab integrated in the bottom side (12) of the high-performance profile (10) close to the rear edge (15).

20. The aerodynamic high-performance profile according to claim 8, characterized in that the high-performance profile is implemented as the main rotor blade of a helicopter.
